(19) United States
(12) Patent Application Publication
(10) Pub. No.: US 2014/0050049 A1
(43) Pub. Date: Feb. 20, 2014

(54) METHODS AND SYSTEMS FOR DEGHOSTING MARINE SEISMIC DATA

(71) Applicant: WESTERNGECO L.L.C., Houston, TX (US)

(72) Inventors: PHILIP W. KITCHENSIDE, ORPINGTON (GB); PHILIPPE CAPRIOLI, COBHAM (GB)

(21) Appl. No.: 13/932,800

(22) Filed: Jul. 1, 2013

Related U.S. Application Data
(60) Provisional application No. 61/683,583, filed on Aug. 15, 2012.

(51) Int. Cl. G01V 1/36

(52) U.S. Cl. CPC G01V 1/36; G01V 2210/56
USPC 367/24

(57) ABSTRACT

A method is provided for deghosting marine seismic data. Marine seismic data is provided. The marine seismic data has a total acoustic wavefield that includes an upgoing acoustic wavefield and a downgoing acoustic wavefield. A deghosting operation to determine a part of the total acoustic wavefield corresponding to one of the upgoing acoustic wavefield and the downgoing acoustic wavefield is performed. The deghosting operation accounts for a varying vertical distance between a detector of a streamer and a sea surface. One of the upgoing and downgoing acoustic wavefields in the total acoustic wavefield is identified based on a result of the deghosting operation. The downgoing acoustic wavefield is removed from the total acoustic wavefield.

### CROSS-REFERENCE TO RELATED APPLICATION

This application claims the benefit of U.S. Provisional Patent Application Ser. No. 61/683,583 filed Aug. 15, 2012, which is incorporated herein by reference in its entirety.

### BACKGROUND

A problem in marine seismic data acquisition is that recorded up-going waves are subsequently reflected downwards at the sea surface and interfere with other up-going waves incident at detector locations along a seismic streamer. Therefore detectors in a seismic streamer cable record the desired wave field (up-going waves due to reflections from various subterranean geological formations) and their time-delayed reflections from the sea surface. This undesirable signal is referred to as a receiver “ghost.” The ghost reflection results in gaps (notches) in the amplitude spectra of the recorded signal and the notches reduce the useful bandwidth of the seismic data. Available deghosting approaches intended to remove the detrimental effects of the receiver ghost assume that the sea surface is flat. However, data may also be acquired in rough-sea conditions and other conditions where a vertical distance between the detector and the sea surface varies.

Accordingly, there is a need for methods and systems that can employ more effective and accurate methods for data processing of collected data that corresponds to a subsurface region for deghosting data collected, for example, during rough-sea conditions.

### SUMMARY

In an example, a method is provided for deghosting marine seismic data. Marine seismic data is provided. The marine seismic data has a total acoustic wavefield that includes an upgoing acoustic wavefield and a downgoing acoustic wavefield. A deghosting operation to determine a part of the total acoustic wavefield corresponding to one of the upgoing acoustic wavefield and the downgoing acoustic wavefield is performed. The deghosting operation accounts for a varying vertical distance between a detector of a streamer and a sea surface. One of the upgoing and downgoing acoustic wavefields in the total acoustic wavefield is identified based on a result of the deghosting operation. The downgoing acoustic wavefield is removed from the total acoustic wavefield.

In another example, a computing system includes a processor, a memory and a program. The memory stores the program. The program includes instructions, which when executed by the processor, are configured to perform a deghosting operation using marine seismic data having a total acoustic wavefield that includes an upgoing acoustic wavefield and a downgoing acoustic wavefield, the deghosting operation determining a part of the total acoustic wavefield corresponding to one of the upgoing acoustic wavefield and the downgoing acoustic wavefield, and the deghosting operation accounting for a varying vertical distance between a detector of a streamer and a sea surface, identify one of the upgoing and downgoing acoustic wavefields in the total acoustic wavefield based on a result of the deghosting operation, and remove the downgoing acoustic wavefield from the total acoustic wavefield.

In another example, a non-transitory computer readable storage medium has stored therein one or more programs. The one or more programs include instructions, which when executed by a processor, cause the processor to perform a deghosting operation using marine seismic data having a total acoustic wavefield that includes an upgoing acoustic wavefield and a downgoing acoustic wavefield, the deghosting operation determining a part of the total acoustic wavefield corresponding to one of the upgoing acoustic wavefield and the downgoing acoustic wavefield, and the deghosting operation accounting for a varying vertical distance between a detector of a streamer and a sea surface, identify one of the upgoing and downgoing acoustic wavefields in the total acoustic wavefield based on a result of the deghosting operation, and remove the downgoing acoustic wavefield from the total acoustic wavefield.

### BRIEF DESCRIPTION OF THE DRAWINGS

For a better understanding of the aforementioned embodiments as well as additional embodiments thereof, reference should be made to the Detailed Description below, in conjunction with the following drawings in which like reference numerals refer to corresponding parts throughout the figures.

FIG. 1 illustrates an up-going pressure wave field reference result.

FIG. 2 illustrates an up-going pressure wave field processed by a technique that assumes flat sea conditions.

FIG. 3 illustrates an up-going pressure wave field processed by a technique that accounts for rough-sea conditions.

FIG. 4A illustrates a ray path geometry for a shallow streamer.

FIG. 4B illustrates a ray path geometry for a deep streamer.

FIG. 5 illustrates data processing metrics for generalized matching pursuit (GMP) techniques for a deep streamer.

FIG. 6 illustrates data processing metrics for GMP techniques for a shallow streamer.

FIG. 7 illustrates a computing system in accordance with some embodiments.

### DETAILED DESCRIPTION

Reference will now be made in detail to embodiments, examples of which are illustrated in the accompanying drawings and figures. In the following detailed description, numerous specific details are set forth in order to provide a thorough understanding. However, it will be apparent to one of ordinary skill in the art that the described techniques may be practiced without these specific details. In other instances, well-known methods, procedures, components, circuits and networks have not been described in detail so as not to obscure aspects of the embodiments.

It will also be understood that, although the terms first, second, etc. may be used herein to describe various elements, these elements should not be limited by these terms. These terms are merely used to distinguish one element from another and do not imply an order or division of elements unless otherwise and specifically stated.

The terminology used herein is for the purpose of describing particular embodiments and is not intended to be limiting. As used in the description and the appended claims, the singular forms “a,” “an” and “the” are intended to include the plural forms as well, unless the context clearly indicates otherwise. It will also be understood that the term “and/or” as used herein refers to and encompasses one or more of the associated listed items and combinations thereof. It will be further understood that the terms “includes,” “including,” “comprises” and/or “comprising,” when used in this specification, specify the presence of stated features, integers, steps, operations, elements and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. In accordance with some embodiments, processing procedures, methods, techniques and workflows are disclosed that include an ability to identify and remove unwanted signal or noise (such as ghosts in collected data).

In some embodiments, a model of acoustic wave propagation is used to determine a “good-fit” (e.g., a “best fit,” a substantially “best-fit,” an improved fit) up-going pressure wave field given a recorded “total” wave field (i.e., up-going wave plus a ghost reflection). The net result is that the down-going reflection (the ghost) is partially or wholly removed from the data. The recorded total wave field may be the acoustic pressure or the acoustic pressure plus additional particle velocity/acceleration wavefields. The particle velocity wave fields may be the vertical velocity or the horizontal velocity in the cross-line direction. The vertical velocity is useful for deghosting since the notches in its spectrum are complementary to those of the pressure wave field. In the generalized matching pursuit (GMP) approach, the horizontal velocity component can be used to perform spatial interpolation in addition to the deghosting. Thus, the horizontal velocity component is particularly useful for typical streamer spacings. In some embodiments, a rough-sea ghost model is incorporated into processing techniques (e.g., by modifying GMP techniques) to account for (e.g., compensate for, include a parameter based on, include a provision for, or otherwise contemplate) a spatially or time varying distance between the streamer and the sea surface.

A sampling of features and/or advantages of varying embodiments of the techniques disclosed herein include, but are not limited to:
rough-sea deghosting and/or interpolation can be performed using the method of generalized matching pursuits
some embodiments formally incorporate the wave-height profile within the GMP formalism
some embodiments operate in the space-frequency domain in order to correctly honor the spatial variation of the sea surface
where estimates of the wave-height profile between streamers are available, some embodiments use a geometrical reconstruction to estimate the height of the reflection point and hence enable a more accurate treatment of non-vertical propagating waves incident at the detectors.

A sampling of applications of the techniques disclosed herein include, but are not limited to:
2-D or 3-D rough-sea single-component deghosting (i.e., pressure data is used)
2-D or 3-D rough-sea deghosting of dual-sensor streamer data (using pressure and vertical particle velocity data)
2-D or 3-D flat-sea deghosting and interpolation of data acquired when cable depths vary
2-D or 3-D rough-sea deghosting and interpolation of data acquired when cable depths vary
2-D or 3-D rough-sea crossline-interpolation and deghosting of multi-component streamer data (using pressure, vertical particle velocity and crossline horizontal particle velocity data)
2-D or 3-D rough-sea deghosting and interpolation of data acquired using slanted cable acquisition (e.g., a streamer orientation where detectors are at increasing, decreasing, or otherwise varying depths)
2-D or 3-D rough-sea deghosting and interpolation of data acquired using over-under acquisition (e.g., cables at different depths)
2-D or 3-D deghosting and interpolation of data acquired in which detector depth is not constant and varies

Some embodiments of the disclosed techniques may utilize a knowledge of, or data related to, the sea surface profile at the detector locations. Time-varying wave-height measurements may be obtained by enabling the acquisition of ultra-low frequency pressure data from which the heights may be derived. For brevity, any data acquired with a time or space varying distance between the detector and the sea surface is generically referenced as a rough-sea condition/model in the following discussion.

In some embodiments, GMP approaches described herein are model-based and parameterized in terms of (or substantially of) one-way wave equation propagators, thereby avoiding finite difference approximations.

To incorporate a rough-sea ghost model, a GMP algorithm is modified with an ansatz that allows for the vertical distance between the streamer and the sea surface (the wave height) to vary spatially and/or in time. GMP iteratively approximates the recorded (input) data with a sum of filtered sinusoidal basis functions. In the GMP algorithm, each basis function is potentially a Fourier component of the up-going pressure wave field and the filters are the associated ghost operators. In some embodiments, the ghost operators map each component of the up-going wavefield into itself plus the ghost reflection. In some embodiments, the frequency-wave number domain form of the ghost operator for the pressure wave field is

G(kₓ, k_{y}, ω)=1.−e^{-i2k}^{_{z}}^{(k}^{ₓ}_{, k}^{_{y}}^{)z} Eq. (1)

where kₓ, k_{y}, k_{z} are respectively the spatial wavenumbers in the horizontal (x, y) and vertical directions. Here, k_{z} (kₓ, k_{y}) denotes the functional dependence of k_{z} on kₓ and k_{y}. Other quantities in Eq. (1) are the frequency w and the streamer depth z (wave height as measured vertically above the streamer). In Eq. (1) the streamer is assumed to be horizontal at a constant depth beneath the sea surface. Note that the ghost operator given by Eq. (1) is 3-D by virtue of the spatial wave numbers kₓ, k_{y}. For brevity of notation the subsequent discussion is directed to the 2-D case, though those with skill in the art will appreciate that the techniques disclosed herein can also be used on true 3-D data.

The space-frequency domain expansion for one frequency component of the total pressure wave field may be written as

$${P}_{total} ( x , ω ) = {\sum }_{{k}_{x}}^{ } a ( {k}_{x} , ω ) G ( {k}_{x} , ω ) {e}^{i {k}_{x} x} , \qquad Eq . ( 2 )$$

where G( ) is the ghost operator and a( ) is the contribution of the basis function e^{ik}^{ₓ}^{x}.

In some embodiments, both a( ) and the basis function are obtained using an iterative algorithm whose convergence is measured by the size of the sum of the differences (residuals) between the approximating sum of filtered basis functions and the input data at detector locations. Each iteration generates a term of the expansion by determining a basis function and the associated a( ) that provide a large contribution to the current sum of the residuals. The residual error at each detector location, which for simplicity is referred to as the error in the following discussion, is then updated by subtracting the contribution so obtained. In equation form, the update to the residual of the pressure wavefield at detector location indexed by j for iteration L+1, may be written as

ε_{j, L+1}^{P}=ε_{j, L}^{P}−a(k_{x, L+1}, ω)G(k_{x, L+1}, ω)e^{ki}^{_{x, L+1}}^{x}^{ⱼ}. Eq. (3)

Here k_{x, L+1} is the wave number corresponding to the basis function selected at iteration L+1. As described below, the method is able to utilize other components of the wavefield such as the vertical and horizontal particle velocities. The residual is then that of the given particle velocity and the form of G( ) may be modified accordingly. In general, the sum of the residuals may be taken over all of the wave field components and all detector locations.

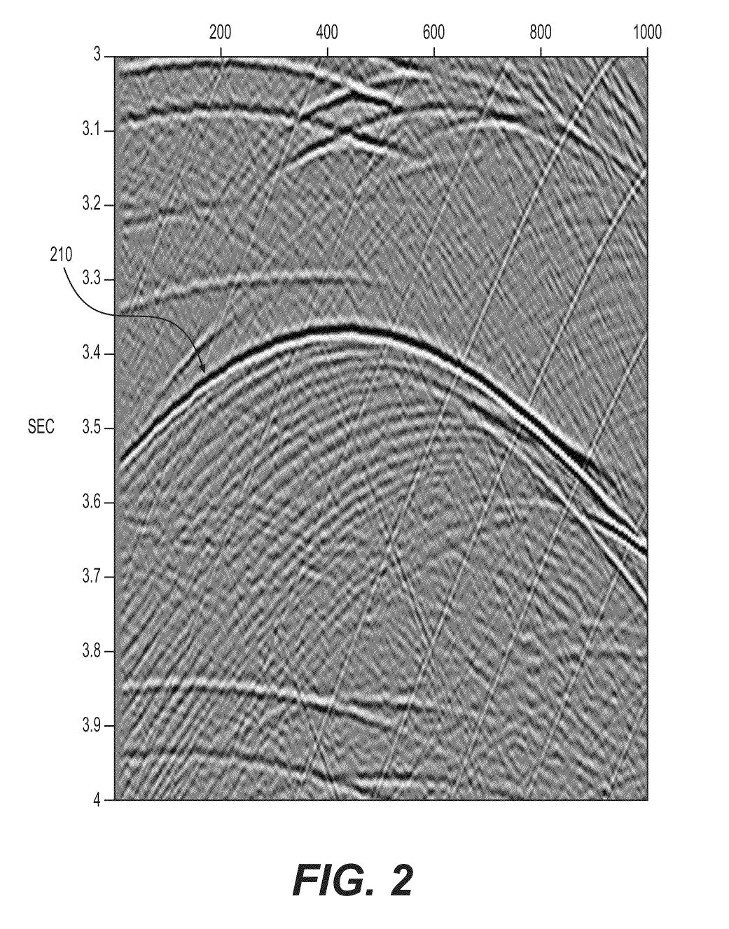

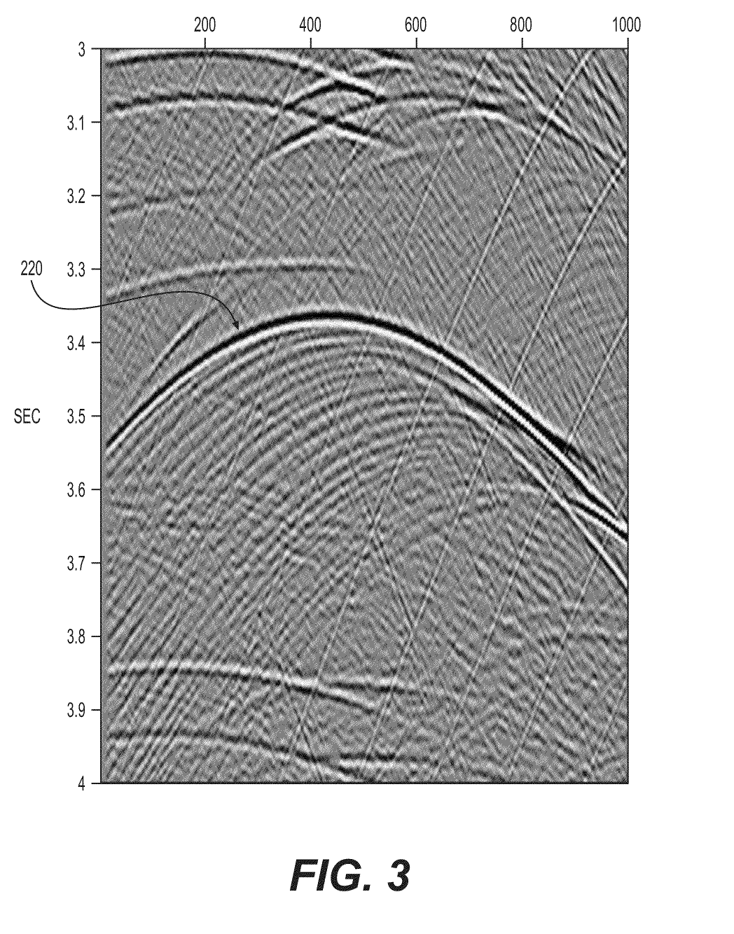

After the residual is updated, the process is repeated during subsequent iterations, thereby reducing the residual until convergence is observed (the residual is below a specified threshold) or a specified maximum number of iterations is attained (e.g., the process is repeated a specified number of times). In the examples of FIGS. 2 and 3, a threshold of 0.01 (i.e., 1%) was used. In such an example, the process may terminate when the ratio of the magnitude of the residual to that of the recorded wavefield attains a value of less than 0.01. The maximum number of iterations may also be specified. In the examples of FIGS. 2 and 3, a maximum number of iterations of 500 was used. The number of iterations may increase with the number of output traces and may depend on the wavefield complexity in addition to other factors. The maximum number of iterations may therefore be determined on a heuristic basis. Experience suggests that an expected value may lie between several hundred and several thousand. Once the expansion of the total wave field is obtained, the deghosted or up-going wavefield is found by dropping the G( ) from the expansion. In other words

$${P}_{up} ( x , ω ) = {\sum }_{{k}_{x}}^{ } a ( {k}_{x} , ω ) {e}^{i {k}_{x} x} , \qquad Eq . ( 4 )$$

The above expansions for the up-going and total wavefields pertain to a datum, namely the depth of the streamer, and in the above analysis, the streamer is assumed to be horizontal. Considering an expansion of the up-going wavefield at an arbitrary horizontal datum, the corresponding total and up-going wavefields at spatial locations follow from the mathematical properties of plane waves. The result is that the a( )'s and G( )'s are modified by phase factors. For example, if the streamer depth z is a function of x, then the up-going and total wavefields at the detector locations xᵣ, z(xᵣ) are given by

$$\begin{matrix}{P}_{total} ( {x}_{r} , ω , z ( {x}_{r} ) ) = {\sum }_{{k}_{x}}^{ } a ( {k}_{x} , ω ) G ( {k}_{x} , ω , z ( {x}_{r} ) ) {e}^{- i {k}_{z} ( z ( {x}_{r} ) - {z}_{D} )} {e}^{i {k}_{x} {x}_{r}} , & Eq . ( 5 ) \\ {P}_{up} ( {x}_{r} , ω , z ( {x}_{r} ) ) = {\sum }_{{k}_{x}}^{ } a ( {k}_{x} , ω ) {e}^{- i {k}_{z} ( z ( {x}_{r} ) - {z}_{D} )} {e}^{i {k}_{x} {x}_{r}} . & Eq . ( 6 )\end{matrix}$$

The xᵣ dependence of G( ) has now been made explicit and that the a( ) coefficients are referenced to a datum z_{D} (i.e., the up-going wavefield at depth z_{D} is given by Eq. 4). These equations allow the a( )'s and kₓs to be determined from data acquired at various measurement locations and allow the up-going wavefield to be determined at various spatial locations. Thus, the described techniques are also applicable to over-under and slanted streamer acquisition geometries.

In addition to pressure data, GMP may use other measurements recorded by multicomponent streamers. Multicomponent streamers may measure vertical and horizontal accelerations in addition to pressure. Accelerations are proportional to corresponding pressure gradients and are the time derivatives of particle velocities. Therefore, measurements of accelerations may be regarded substantially as equivalent to measurements of pressure gradients or particle velocities. Let the superscript i denote a particular component (e.g., pressure or a particle velocity). Then the residual at spatial location j for iteration L+1 is given by

ε_{j, L+1}ⁱ=ε_{j, L}ⁱ−a(k_{x, L+1})Ψ_{j, L+1}ⁱ, Eq. (7)

where

ψ_{j, L+1}ⁱ=Gⁱ(k_{x, L+1}, ω)e^{ik}^{_{x, L−1}}^{x}^{ⱼ}, Eq. (8)

is the ghost operator for the i'th component of the wavefield multiplied by the basis function under consideration. The i superscript of G signifies that the functional form of the ghost operator is different for the different components. Note that the i in ik_{x, L+}1 denotes the imaginary number, not a particular component of the wavefield. For the rough-sea formulation and for the case of three components (pressure and vertical particle velocity and horizontal particle velocity) we have that

$$\begin{matrix}{ψ}_{j , L + 1}^{0} = ( 1. - {e}^{- i 2 {k}_{z} ( {k}_{x , L + 1} ) {z}_{j}} ) {e}^{i {k}_{x , L + 1} {x}_{j}} = {G}^{0} ( {k}_{x , L + 1} , ω ) {e}^{i {k}_{x , L + 1} {x}_{j}} & Eq . ( 9 ) \\ {ψ}_{j , L + 1}^{1} = - \frac{{k}_{z}}{ω} ( 1. + {e}^{- i 2 {k}_{z} ( {k}_{x , L + 1} ) {z}_{j}} ) {e}^{i {k}_{x , L + 1} {x}_{j}} = {G}^{1} ( {k}_{x , L + 1} , ω ) {e}^{i {k}_{x , L + 1} {x}_{j}} & Eq . ( 10 ) \\ {ψ}_{j , L + 1}^{2} = - \frac{{k}_{x}}{ω} ( 1. + {e}^{- i 2 {k}_{z} ( {k}_{x , L + 1} ) {z}_{j}} ) {e}^{i {k}_{x , L + 1} {x}_{j}} = {G}^{2} ( {k}_{x , L + 1} , ω ) {e}^{i {k}_{x , L + 1} {x}_{j}} , & Eq . ( 11 )\end{matrix}$$

where the superscripts 0, 1, 2 denote the pressure, vertical particle velocity and horizontal particle velocity, respectively.

Note that for the rough-sea case the streamer depth z is now subscripted by the index j in order to incorporate for the spatial variation of the wave height. It will be appreciated that this representation extends beyond the rough-sea case. For example, even if the rough-sea aspect is disregarded, the variable z formalism is still applicable to the case of a calm sea where the depth of a streamer varies. In such a case, the sea surface may be assumed to be horizontal, and zⱼ may be used to specify the spatially varying streamer depth. Hence the variable z formalism facilitates the deghosting and spatial interpolation of data acquired when the streamer depth varies.

The optimal value of a( ) which minimizes the residual at iteration L+1 is given by

$$a ( {k}_{x , L + 1} ) = \frac{{\sum }_{i}^{ } {λ}^{i} {\sum }_{j}^{ } {ɛ}_{j , L}^{i} {ψ}_{j , L + 1}^{i *}}{{\sum }_{i}^{ } {λ}^{i} {\sum }_{j}^{ } {\vert {G}_{j , L + 1}^{i} \vert}^{2}} \qquad Eq . ( 12 )$$

where the lambda parameters are weights which may be applied to the residuals corresponding to the different components. Note also that the sum over j (spatial location index) does not feature in the flat-sea case since G( ) is spatially invariant.

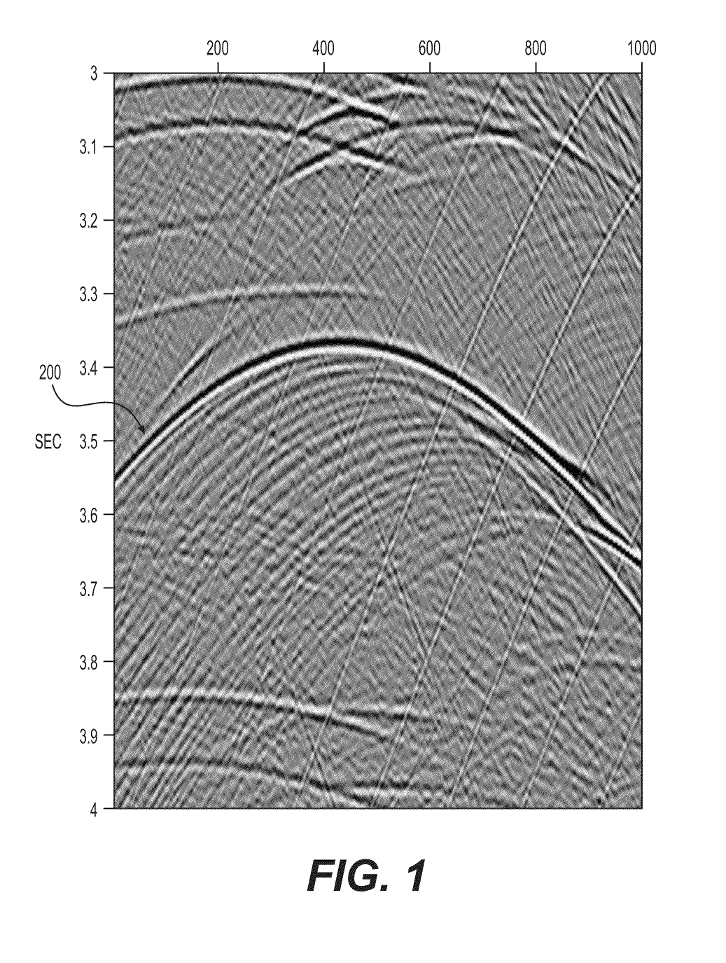

FIG. 1 shows an up-going pressure wave field, which is taken to be a reference result. The dominant event 200 corresponding to the main feature approximately between 3.4 and 3.6 seconds is smooth in the reference result.

FIG. 2 shows an up-going pressure wave field obtained by processing acquired data with available processing techniques that assume flat sea conditions. The dominant event 210 corresponding to the main feature approximately between 3.4 and 3.6 seconds includes undesirable perturbations due to surface roughness. The output trace sampling is 3.125 m in this example.

FIG. 3 shows an up-going pressure wave field obtained by processing acquired data with a GMP accounting for rough-sea conditions. The dominant event 220 corresponding to the main feature approximately between 3.4 and 3.6 seconds has substantially reduced perturbations as compared to the dominant event 210. The output trace sampling is 3.125 m in this example.

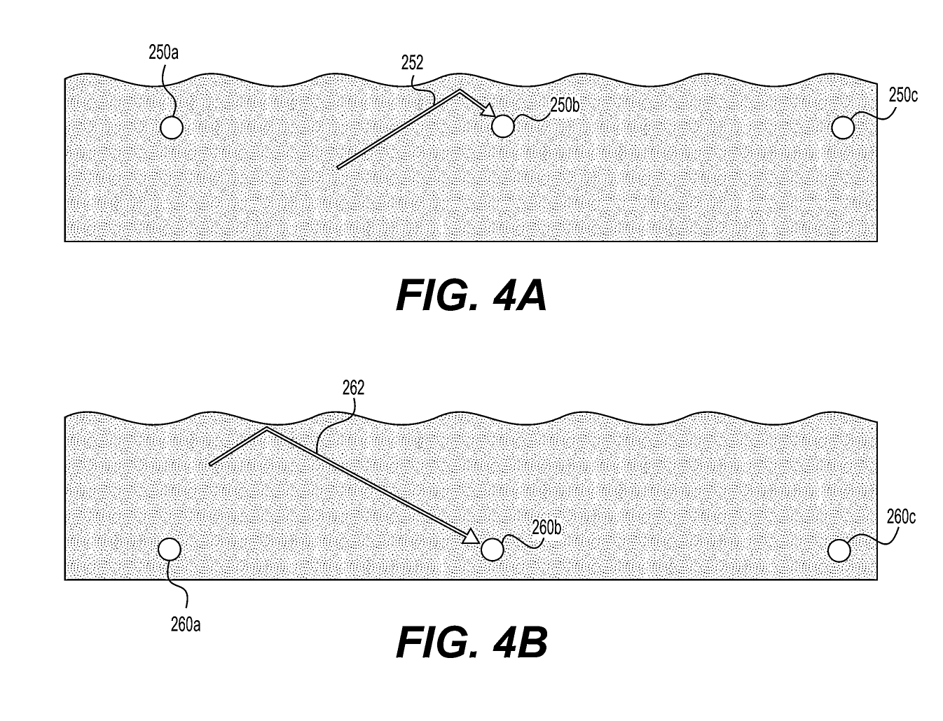

If the wave-height profile has been reconstructed between the streamers, accuracy improvements follow from geometrical considerations. The principle is illustrated by the conceptual example of FIGS. 4A (with reference to a shallow streamer) and 4B (with reference to a deep streamer). The schematics are cross-line profiles taken at the detector locations 250, 260 and show an end-on view of three deep streamers (260a, 260b, 260c) and three shallow streamers (250a, 250b, 250c), the streamers are perpendicular to the page. The schematic of FIG. 4A shows three streamers from a shallow streamer acquisition (e.g., at streamer depths of around 4 m, 8 m). The schematic of FIG. 4B shows a deep streamer configuration (e.g., a streamer depth of around 20 m or more). The lines 252, 262 indicate two example ray paths of data recorded at the detectors after downward reflection by the sea surface. The sea surface reflection points for non-vertically propagating waves are laterally-offset from the detector locations at which they are recorded, and the deeper the streamer, the larger the lateral offset of the reflection point.

In equation (1), zⱼ refers to the depth of the streamer below the sea surface at the trace location indexed by j and gives the phase-shift appropriate for this depth, whereas the depth at the reflection point may provide increased accuracy. Increased accuracy is obtained from using the angle of incidence and the mean wave height to calculate the approximate lateral offset of the reflection point from the detector location. Each iteration of the GMP algorithm proceeds by selecting sinusoidal basis functions from the basis dictionary and each basis function has a corresponding spatial wavenumber kₓ, k_{y}, which in turn define the angle of propagation. For the 2-D case, the angle of propagation is given by

$$sin θ = \frac{{vk}_{x}}{ω} \qquad Eq . ( 13 )$$

In 3-D there is also an azimuthal angle in the direction specification:

$$sin θ = \frac{v}{ω} \sqrt{{k}_{x}^{2} + {k}_{y}^{2}} , \\ tan φ = \frac{{k}_{x}}{{k}_{y}} \qquad Eq . ( 14 )$$

The angles of propagation can then be used together with the mean wave height zₘ to approximate the lateral offset (l) of the reflection point. In the 2-D case this is given by

l=zₘ tan θ Eq. (16)

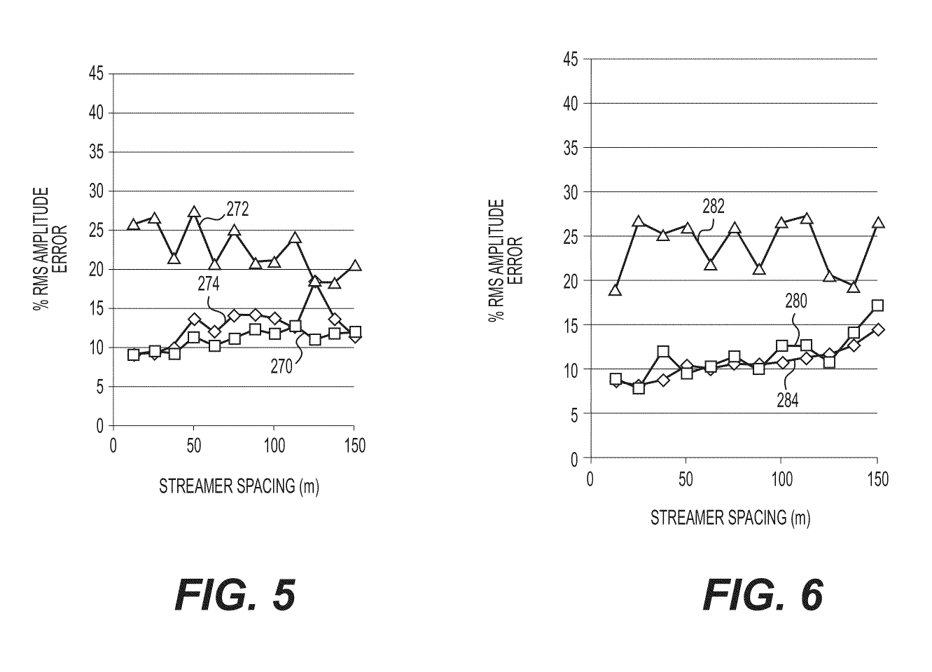

The wave height at the computed lateral offset can then be determined and used in eq. (1) in place of the wave height above the hydrophone. FIG. 5 shows an example of RMS error measurements for 11 streamers towed at a depth of 20 m. FIG. 6 shows an example of RMS measurements for 11 streamers towed at a depth of 8 m. In FIGS. 5 and 6, this methodology has been used to compute the RMS error measures indicated by curves 270, 280. Curves 272, 282 correspond to RMS error measures obtained using a flat-sea GMP algorithm and curves 272, 284 correspond to RMS error measures obtained using the rough-sea GMP algorithm where the wave heights are known/determined at the streamer locations. The RMS error measures an averaged error in the computed up-going pressure wave field.

The curves in these examples show the error for a given number of streamers plotted as a function of the cross-line streamer spacing. Varying the number of streamers and also their spacing provides a way of evaluating the accuracy of the rough-sea GMP interpolation and deghosting in as a function of these variables. The accuracy was measured by computing the RMS error between the GMP output and the up-going wave field within a short time window about the up-going event. FIG. 5 shows that for 11 streamers at a depth of 20 m, information of the wave heights between the streamers (curve 270) gives a consistently smaller error for the larger streamer spacings. For a streamer depth of 8 m, FIG. 6 shows that the additional wave-height information may not be as noticeable. This is because for a given propagation angle, the lateral offset of the reflection point becomes larger as the streamer depth increases. Hence on average the wave height at the reflection point differs more from the wave height at the detector location. The additional wave-height information helps to compensate for the error due to using the wave height at the detector location in Eq. (1).

The steps in the processing methods described above may be implemented by running one or more functional modules in an information processing apparatus such as general purpose processors or application specific chips, such as ASICs, FPGAs, PLDs, or other appropriate devices. These modules, combinations of these modules, and/or their combination with general hardware are included within the scope of the disclosure.

### Computing Systems

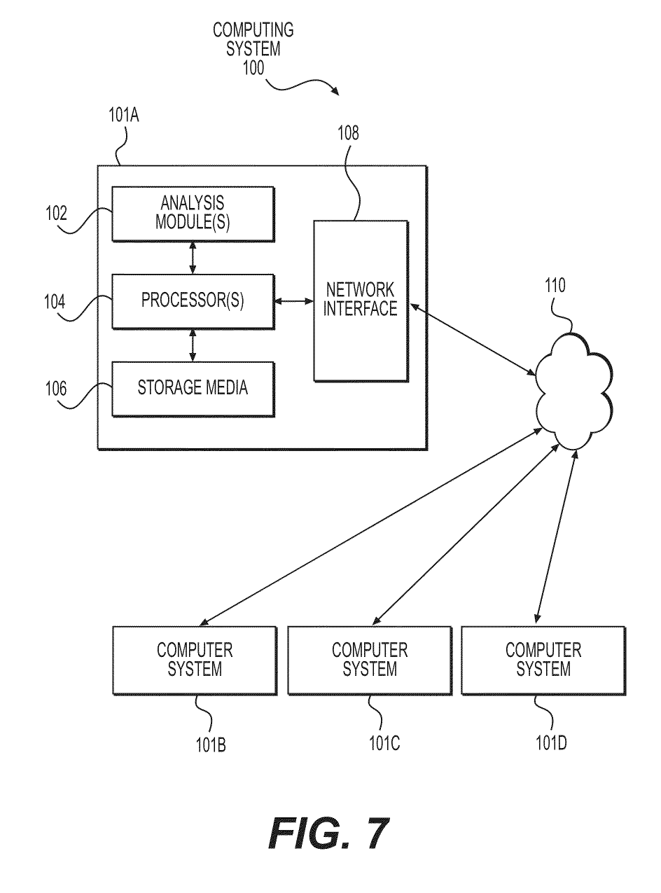

FIG. 7 depicts a computing system 100A. The computing system 100A can be an individual computer system 101A or an arrangement of distributed computer systems. The computer system 101A includes one or more analysis modules 102 that are configured to perform various tasks according to some embodiments, such as one or more methods disclosed herein (e.g., any of the methods, combinations of techniques, and/or variations thereof). To perform these various tasks, analysis module 102 executes independently, or in coordination with, one or more processors 104, which is (or are) connected to one or more storage media 106A. The processor(s) 104 is (or are) also connected to a network interface 108 to allow the computer system 101A to communicate over a data network 110A with one or more additional computer systems and/or computing systems, such as 101B, 101C, and/or 101D (note that computer systems 101B, 101C and/or 101D may or may not share the same architecture as computer system 101A, and may be located in different physical locations, e.g., computer systems 101A and 101B may be on a ship underway on the ocean, while in communication with one or more computer systems such as 101C and/or 101D that are located in one or more data centers on shore, other ships, and/or located in varying countries on different continents).

A processor can include a microprocessor, microcontroller, processor module or subsystem, programmable integrated circuit, programmable gate array, or another control or computing device.

The storage media 106A can be implemented as one or more computer-readable or machine-readable storage media. Note that while in the embodiment of FIG. 7 storage media 106A is depicted as within computer system 101A, in some embodiments, storage media 106A may be distributed within and/or across multiple internal and/or external enclosures of computing system 101A and/or additional computing systems. Storage media 106A may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays or other optical media; or other types of storage devices. “Non-transitory” computer readable medium refers to the medium itself (i.e., tangible, not a signal) and not data storage persistency (e.g., RAM vs. ROM).

Note that the instructions discussed above can be provided on one computer-readable or machine-readable storage medium, or can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computing system 100A is one example of a computing system, and that computing system 100A may have more or fewer components than shown, may combine additional components not depicted in the embodiment of FIG. 7, and/or computing system 100A may have a different configuration or arrangement of the components depicted in FIG. 7. The various components shown in FIG. 7 may be implemented in hardware, software, or a combination of both hardware and software, including one or more signal processing and/or application specific integrated circuits.

Further, the steps in the processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the disclosure.

The foregoing description, for purpose of explanation, has been described with reference to specific embodiments. However, the illustrative discussions above are not intended to be exhaustive or limiting to the precise forms disclosed.

For example, in some embodiments, the deghosting operation may include a generalized matching pursuit; the deghosting operation may account for a time varying vertical distance between the detector of the streamer and the sea surface; the deghosting operation may account for a spatially varying vertical distance between the detector of the streamer and the sea surface; the deghosting operation may account for a wave height; the deghosting operation may account for an angle of incidence of a ray path of a downward reflection and the wave height; the wave height may be a mean wave height; the performing the deghosting operation may be repeated iteratively; the performing the deghosting operation may be repeated iteratively until an error is below a threshold; the performing the deghosting operation may be repeated a specific number of times; the deghosting operation may include an algorithm that includes a parameter representing the vertical distance between the detector of the streamer and the sea surface; the parameter may be indexed to vary in time; the parameter may be indexed to vary in space; the marine seismic data may be acquired in rough-sea conditions; the marine seismic data may be acquired using a slanted streamer; the marine seismic data may include dual-sensor streamer data; a computing system may include a processor, a memory that stores a program, and a means for performing described methods; and/or an information processing apparatus for use in a computer system may include a means for performing described methods.

Further, many modifications and variations are possible in view of the above teachings.

Features shown in individual embodiments referred to above may be used together in combinations other than those which have been shown and described specifically. Accordingly, such modifications are intended to be included within the scope of this disclosure as defined in the following claims. In the claims, means-plus-function clauses are intended to cover the structures described herein as performing the recited function and not only structural equivalents, but also equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method for deghosting marine seismic data, comprising:
providing marine seismic data, the marine seismic data having a total acoustic wavefield that includes an upgoing acoustic wavefield and a downgoing acoustic wavefield;
performing a deghosting operation to determine a part of the total acoustic wavefield corresponding to one of the upgoing acoustic wavefield and the downgoing acoustic wavefield, the deghosting operation accounting for a varying vertical distance between a detector of a streamer and a sea surface;
identifying one of the upgoing and downgoing acoustic wavefields in the total acoustic wavefield based on a result of the deghosting operation; and
removing the downgoing acoustic wavefield from the total acoustic wavefield.

2. The method of claim 1, wherein the deghosting operation includes a generalized matching pursuit.

3. The method of claim 1, wherein the deghosting operation accounts for a time varying vertical distance between the detector of the streamer and the sea surface.

4. The method of claim 1, wherein the deghosting operation accounts for a spatially varying vertical distance between the detector of the streamer and the sea surface.

5. The method of claim 1, wherein the deghosting operation accounts for a wave height.

6. The method of claim 5, wherein the deghosting operation accounts for an angle of incidence of a ray path of a downward reflection and the wave height.

7. The method of claim 6, wherein the wave height is a mean wave height.

8. The method of claim 1, wherein the performing the deghosting operation is repeated iteratively.

9. The method of claim 8, wherein the performing the deghosting operation is repeated iteratively until an error is below a threshold.

10. The method of claim 8, wherein the performing the deghosting operation is repeated a specific number of times.

11. The method of claim 1, wherein the deghosting operation includes an algorithm that includes a parameter representing the vertical distance between the detector of the streamer and the sea surface.

12. The method of claim 11, wherein the parameter is indexed to vary in time.

13. The method of claim 11, wherein the parameter is indexed to vary in space.

14. The method of claim 1, wherein the providing includes providing marine seismic data acquired in rough-sea conditions.

15. The method of claim 1, wherein the providing includes providing marine seismic data acquired using a slanted streamer.

16. The method of claim 1, wherein the marine seismic data includes dual-sensor streamer data.

17. A computing system, comprising:
a processor; and
a memory that stores a program, wherein
the program includes instructions, which when executed by the processor, are configured to
perform a deghosting operation using marine seismic data having a total acoustic wavefield that includes an upgoing acoustic wavefield and a downgoing acoustic wavefield, the deghosting operation determining a part of the total acoustic wavefield corresponding to one of the upgoing acoustic wavefield and the downgoing acoustic wavefield, and the deghosting operation accounting for a varying vertical distance between a detector of a streamer and a sea surface,
identify one of the upgoing and downgoing acoustic wavefields in the total acoustic wavefield based on a result of the deghosting operation, and
remove the downgoing acoustic wavefield from the total acoustic wavefield.

18. The computing system of claim 17, wherein the deghosting operation accounts for a time varying vertical distance between the detector of the streamer and the sea surface.

19. A non-transitory computer readable storage medium, which has stored therein one or more programs, the one or more programs including instructions, which when executed by a processor, cause the processor to
perform a deghosting operation using marine seismic data having a total acoustic wavefield that includes an upgoing acoustic wavefield and a downgoing acoustic wavefield, the deghosting operation determining a part of the total acoustic wavefield corresponding to one of the upgoing acoustic wavefield and the downgoing acoustic wavefield, and the deghosting operation accounting for a varying vertical distance between a detector of a streamer and a sea surface,
identify one of the upgoing and downgoing acoustic wavefields in the total acoustic wavefield based on a result of the deghosting operation, and
remove the downgoing acoustic wavefield from the total acoustic wavefield.

20. The computer readable storage medium of claim 19, wherein the deghosting operation accounts for a time varying vertical distance between the detector of the streamer and the sea surface.
